(19) United States
(12) Patent Application Publication
(10) Pub. No.: US 2009/0302596 A1
(43) Pub. Date: Dec. 10, 2009

(54) Coupling for connecting a capillary tube to a mixer

(75) Inventor: Wilhelm A. Keller, Merlischachen (CH)

Correspondence Address: FOLEY AND LARDNER LLP;SUITE 500, 3000 K STREET NW, WASHINGTON, DC, 20007, US

(73) Assignee: MIXPAC SYSTEMS AG

(21) Appl. No.: 12/461,462

(22) Filed: Aug. 12, 2009

Related U.S. Application Data
(62) Division of application No. 10/558,761, filed on Dec. 1, 2005, now abandoned.

(30) Foreign Application Priority Data
Jun. 3, 2003 (CH) 2003 0979/03

(51) Int. Cl. F16L 13/02; F16L 33/00

(52) U.S. Cl. 285/21.3; 285/248

(57) ABSTRACT

The coupling for connecting a tube (2) to a commercially available mixer or mixer accessory comprises an adapter (3) and a fastening piece (4), the adapter being provided at one end with an insertion portion (8) and at the other end with a receiving portion (12), and the fastening piece being pushed over the adapter. A coupling of this type allows the secure and simple use of capillary tubes, e.g. for medical technique.

The present invention refers to a coupling for connecting a capillary tube to a mixer or a mixer accessory.

For certain applications, mainly in the dental or medical fields, it is often necessary to connect a fine tube, also called capillary tube, in order to be able to apply the mixed composition punctually also at difficulty accessible locations.

EP-A-0 091 773 discloses a coupling for a pressure hose in compressed air control systems where the hose is slotted and is under the action of a clamp. Such an arrangement is not suitable for dental or medical technique.

EP-A-0 368 377 discloses an implantable injection chamber where the chamber is provided with a tube in which a catheter is inserted that is subsequently fastened by means of a clamping ring.

U.S. Pat. No. 4,013,310 relates to a coupling for connecting a tube to a connecting device, the tube being inserted in a flexible, slotted outlet portion of the device and secured by a slidable collet ring.

U.S. Pat. No. 4,690,306 relates to a coupling between an outlet portion and a mixer that is secured by means of a screw cap, however.

U.S. Pat. No. 4,771,919 discloses an attachment of a mixer to a cartridge by means of an adjustable coupling ring.

U.S. Pat. No. 3,971,576 refers to a hose coupling for pneumatic circuits.

On the background of this prior art, it is an object of the present invention to provide a tight coupling of a capillary tube for connection to a mixer or a mixer accessory, which is applicable for dental and medical technique, allows an inexpensive manufacture using commercially available mixers, and is simple to use. This is accomplished by a coupling as described in claim 1.

The invention will be explained in more detail hereinafter with reference to drawings of an exemplary embodiment.

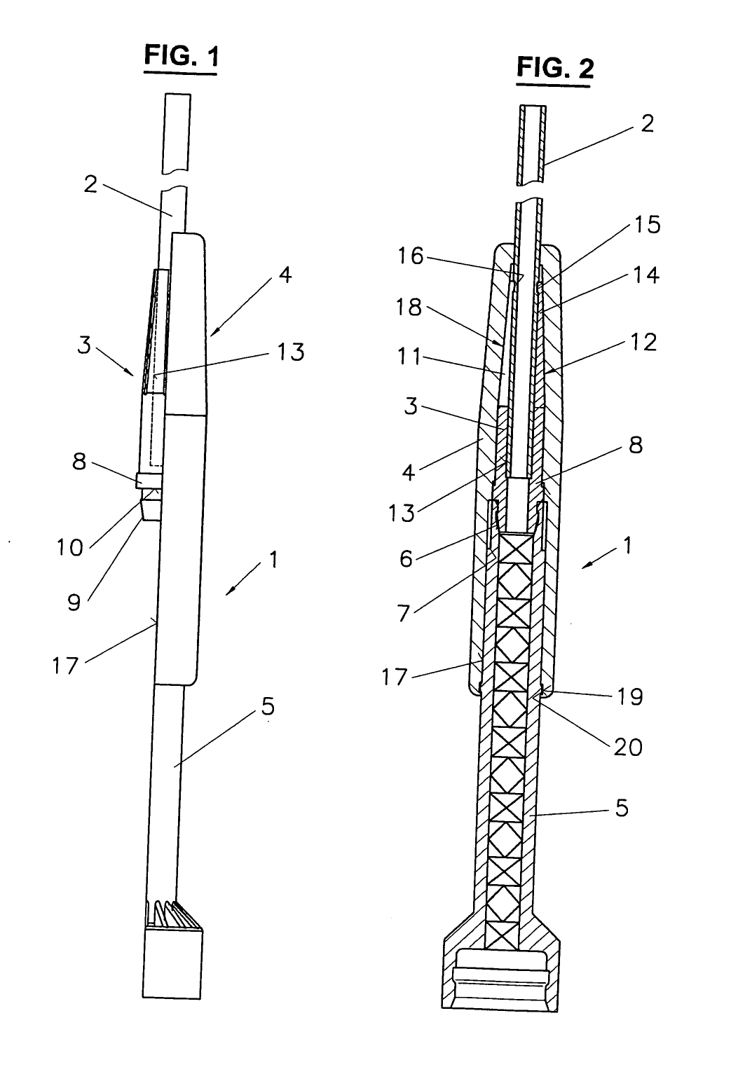

FIG. 1 shows an exemplary embodiment in a cutaway lateral view, and

FIG. 2 shows the exemplary embodiment of FIG. 1 in a longitudinal section.

FIG. 1 illustrates a part of a mixer 1 and a capillary tube 2 for connection thereto, the latter being made of a rigid material, e.g. of metal, or of a resilient material, e.g. of a plastics material, as well as an adapter 3 and a fastening piece 4. Essentially, only mixer housing 5 of the mixer is shown. The mixer resp. the mixer housing is conventional and has been on the market for some time now. In this context, it is of particular interest that an internal groove 6 and an external shoulder 7 are provided on the mixer outlet end.

Adapter 3 has an insertion end 8 that is pushed into the mixer outlet and is provided with a conical end portion 9 with a shoulder 10, while a conical retaining portion 12 provided with slots 11 is arranged at the other end. Slots 11 define retaining fins 14. Bore 13 in the retaining portion, which corresponds to the external diameter of the capillary tube, extends into the insertion end of the adapter.

At least one of retaining fins 14 is provided near its end with an inwardly directed nose 15 that engages in a corresponding notch or annular groove 16 of the capillary tube to retain it. This is generally the case if the capillary tube is of metal. If the capillary tube is made of a resilient material, the nose will impress itself into the material of the capillary tube and thereby retain it.

Another component is fastening piece 4, the inside of which is composed of a cylindrical portion 17 and a conical portion 18 that tapers toward the end. It is further apparent that the mixer side end of fastening piece 4 is provided with an internal circular groove 20 allowing a corresponding external bead or projections 19 of the mixer end to snap in or to be snapped in. Other snap-action elements such as noses and notches may also be used.

Before securing a tube or capillary tube, the adapter is pushed into the mixer outlet as far as possible until shoulder 9 engages behind internal groove 6 on the mixer, snaps in, and retains the adapter.

Then the capillary tube is pushed into the adapter as far as possible and fastening piece 4 is pushed home, thereby compressing the retaining fins of the adapter and providing a secure retention of the capillary tube.

Within the scope of this embodiment, it is also conceivable to use a different fastening piece, e.g. one having a screw thread, to achieve a better retention on the mixer housing or, similarly to the notch or the circular groove on the capillary tube, to provide such a notch or another retaining element on the mixer and at one end of the fastening piece. It is also possible to secure the fastening piece to the mixer by cementing.

In a further exemplary embodiment, instead of using a separate retaining portion, the retaining fins are directly injection-molded on the mixer outlet or separately produced and securely connected thereto. This solution allows simplifying the entire attachment of a capillary tube. The fastening piece is the same as previously described or has an analogous configuration and the same function.

1.-7. (canceled)

8. A device, comprising:
a mixer or mixer accessory; and
a capillary tube for connection to the mixer or mixer accessory, wherein the mixer or mixer accessory includes a mixer housing comprising a mixer outlet,
wherein the mixer outlet includes a retaining portion configured to retain the capillary tube, and wherein the retaining portion includes a bore which corresponds to an external diameter of the capillary tube.

9. A device according to claim 8, wherein the retaining portion comprises a plurality of retaining fins.

10. A device according to claim 9, wherein the retaining fins are configured to be directly injection molded on the mixer outlet.

11. A device according to claim 9, wherein the retaining fins are configured to be separately produced and securely connected to the mixer outlet.

12. A device according to claim 8, wherein the retaining portion is configured to be an adapter, wherein the adapter includes an insertion end that is configured to be pushed into the mixer outlet and is provided with a conical end portion with a shoulder.

13. A device according to claim 12, wherein the bore extends into the insertion end of the adapter.

14. A device according to claim 12, wherein the adapter includes another end, which is arranged on an end of the adapter opposite the insertion end, wherein the another end includes a conical end portion, and wherein the conical end portion includes a plurality of slots.

15. A device according to claim 14, wherein each slot of the plurality of slots defines a plurality of retaining fins.

16. A device according to claim 15, wherein at least one of the plurality of retaining fins includes an inwardly directed nose provided near an end of the at least one retaining fin, the inwardly directed nose is configured to engage with a corresponding notch or annular groove of the capillary tube to retain the capillary tube.

17. A device according to claim 8, further comprising a fastening piece placed onto the mixer housing at the mixer outlet, the fastening piece configured to receive the adapter and a portion of the capillary tube.

18. A device according to claim 17, wherein the fastening piece comprises a retaining element configured to engage with a corresponding element on the mixer housing.

19. A device according to claim 17, wherein the fastening piece includes an internal circular groove configured to engage in a snap connection with a corresponding external bead or projection arranged at an outer periphery of the mixer outlet.

20. A device according to claim 17, wherein the fastening piece comprises a screw thread.

21. A device according to claim 17, wherein the fastening piece is configured to be secured to the mixer housing by cementing.
